(19) United States
(12) Patent Application Publication
(10) Pub. No.: US 2024/0001597 A1
(43) Pub. Date: Jan. 4, 2024

(54) FOAM FORMING DEVICE AND FOAM EXTRUSION APPARATUS

(71) Applicant: Frank van Lück, Willich (DE)

(72) Inventor: Frank van Lück, Willich (DE)

(21) Appl. No.: 18/038,289

(22) PCT Filed: Nov. 27, 2021
(86) PCT No.: PCT/EP2021/083261

§ 371 Date: May 23, 2023

(30) Foreign Application Priority Data
Dec. 10, 2020 (DE) 10 2020 215 683.2

(51) Int. Cl. B29C 44/50; B29C 48/25; B29C 48/92; B29C 48/90; B29C 48/00; B29C 48/31

(52) U.S. Cl. CPC B29C 44/505; B29C 48/252; B29C 48/92; B29C 48/903; B29C 48/0012; B29C 48/31; B29C 2043/5816

(57) ABSTRACT

A foam forming device has an inlet, an outlet and a longitudinal axis that leads from the inlet to the outlet. The foam forming device has a plurality of surface pairs. Each surface pair has two opposing surfaces. The surfaces delimit a foaming space at least to some extent. At least one of the surfaces of the surface pairs is an adjustable surface whose orientation relative to the longitudinal axis can be adjusted. The first surface pair and the second surface pair are off-set from one another along the periphery of the foaming space. Also disclosed is a foam extrusion apparatus having a foam forming device.

### CROSS REFERENCE TO RELATED APPLICATIONS

This application is a U.S. National Phase Application of PCT International Application No. PCT/EP2021/083261, filed Nov. 27, 2021, which claims benefit of priority from German Application No. 10 2020 215 683.2, filed Dec. 10, 2020. The contents of these applications are incorporated herein by reference.

### BACKGROUND OF THE INVENTION

Molten plastics material is displaced with propellant in order to produce a foam member from plastics material. At the outlet of a die, the melt foams, whereby the foam member is produced. In order to guide the foaming process and to obtain a desired form, there are known apparatuses which limit the foaming melt by means of faces and thus form the foam member. For instance, during the production of plastics webs, the cross section of the foam member is thereby defined.

The publication DE 10 2016 011 039 A1, incorporated herein by reference, proposes a foam extrusion die which has two opposite guide faces. The guide faces are movable so that the angle between the guide faces can be adjusted. The thickness of the foam member is thereby defined.

### SUMMARY OF THE INVENTION

It has been recognized that, although the foam member can be defined in one direction by a guide at only two faces, the foaming process cannot be guided sufficiently in a direction extending transversely thereto. This results in non-homogeneous pore formation. Therefore, an aspect of the invention aims to provide a possible method which allows a foam member with defined dimensions and with pores which are distributed as homogeneously as possible and pore sizes which are as homogeneous as possible also to be produced.

Therefore, there is proposed a foam forming device which can adjoin an extruder (or the discharge die thereof), from which plastics melt which is displaced with propellant is discharged. The foam forming device has an inlet and an outlet. The foam forming device has a longitudinal axis, which leads from the inlet to the outlet. The foam forming device has a plurality of face pairs. Each face pair has at least two opposite faces. The faces of the face pairs are arranged beside each other circumferentially in rows. The different face pairs delimit the foaming space at different circumferential locations; therefore, there is a delimitation not only by means of a face pair, but also by means of several face pairs which are arranged at different locations of the circumference of the foaming space. The circumference is located in a cross sectional surface-area, that is to say, in a face or plane which is passed through by the longitudinal axis or the conveying direction, preferably at a substantially perpendicular angle. In other words, with respect to the cross section of the device, different face pairs are provided at different locations. With respect to the longitudinal axis of the device, the faces of a first face pair are provided at first angle portions and the faces of at least a second face pair are provided at second angle portions which are different from the first angle portions and particularly do not overlap or overlap the first angle portions only at an edge region. Faces of the first and second face pairs are arranged in rows beside each other circumferentially (for instance, with respect to the longitudinal axis); the faces of the first and second face pairs alternate circumferentially with each other. In the case of a plurality of face pairs (more than two) which adjoin the inlet, the faces of the plurality of face pairs are preferably arranged in rows beside each other. The normals of the first and second face pairs are angularly offset relative to each other. The face pairs result in a substantially circumferential delimitation or a delimitation for a plurality of circumference portions of the foaming space. The first and second face pairs are particularly orientated differently relative to the longitudinal axis.

The foaming mass can thereby be produced with a homogeneous pore distribution because a plurality of face pairs which are provided circumferentially at different locations (of the cross section) are provided. The foam member therefore does not grow during foaming in a direction delimited by faces and in another direction (angularly offset relative thereto) in an unlimited manner but instead has in different directions a similar foaming speed as a result of the faces which delimit and guide the foaming process at different circumferential locations of the cross section or the foam member. The foaming mass is particularly prevented from being able to expand unchecked in a direction (for instance, laterally) while faces limit the foaming in another direction (for instance, in a vertical direction). It is further not only possible to define the thickness of the resultant foam member but the desired cross sectional form can also be defined, for instance, the edge lengths of a quadrangular cross section.

An adjustment of the die gap thickness, as known from the prior art, may allow a thickness adjustment, but, since the majority of the foaming operation takes place after the die gap, this foaming can no longer be controlled by the die gap thickness and great variations in thickness occur. These variations are usually removed by corresponding subsequent processing steps (planning, cutting, etc.), but with this, on the one hand, damaging the closed surface of the foam web and, on the other hand, leading to waste. In contrast, an aspect of the invention allows the form and face of the foam web to be processed during the production (foaming) of the foam web. It is thereby possible to achieve a substantially more precise thickness formation and forming because a substantially longer time period of the foaming can be controlled by the faces. Therefore, subsequent processing is necessary only to a substantially smaller degree or not at all. While, in the case of the apparatus according to the prior art, only a small number of screws can be used to adjust the thickness at the gap, an aspect of the invention allows adjustment of the thickness of the foam web at a location at which it is foamed in a substantially wider manner and consequently more extensively so that substantially more adjustment members can act over the entire width of the foam web. This allows a finer adjustment and also an adjustment under substantially smaller pressure loads of the adjustment members than at the gap, at which the melt is still under comparatively high pressure.

Another advantage involves particularly planar faces, which can again be laminated with a non-foamed plastics layer, being able to be produced as a result of the surface processing enabled with an aspect of the invention. The laminated web can then be smoothed by the apparatus described herein. A number of plastics materials, for example, polystyrene, cannot be expanded powerfully so that they can be applied either only with pressure and/or at high temperature (wherein this excludes the application to a still-warm foam web or disadvantageously deforms the foam member). During a thickness correction only at the gap die, that is to say, at the inlet, the surface would be too uneven. However, an aspect of the invention allows a smooth, still-warm foam web, on which poorly extensible plastics material (as a laminate material), such as, for example, polystyrene can also be applied.

Furthermore, as a result of the forming according to an aspect of the invention of the foamed melt after the die, that is to say, at locations at which the foam is already foamed to an extremely large extent, there is less pressure which is applied by the foam to the forming elements (here: faces). The foam form can thereby be defined by the faces more precisely and with less complexity. In particular, no significant bending is also produced in the case of thin sheets or plates which the faces provide as a result of the lower pressure.

The positioning (that is to say, inclination and/or spacing) of at least one of the faces can be adjusted relative to the longitudinal axis of the foam forming device or relative to the conveying direction of the foam member, whereby the foaming process can be controlled. In particular, an effect can thereby be applied to different properties in a compensating manner in the case of changes in temperature or viscosity of the plastics melt. The at least one adjustable face can be adjusted in the context of a control or regulation. The adjustable face is preferably adjustable via a control signal, for instance, via an electrical, pneumatic or hydraulic control signal. Consequently, not all faces of the face pairs are arranged rigidly relative to each other, but instead an adaptation to process parameters, such as temperature, conveying speed or the like can be carried out in order thus to allow a homogeneous foaming process with changeable process parameters. The compensation for fluctuations of at least one process parameter is carried out at least partially by adjusting the at least one adjustable face. Preferably, both faces of at least one face pair or all the face pairs are adjustable. The following are adjustable: the spacing of faces of a face pair and/or the inclination of the faces of the face pairs relative to the longitudinal axis and/or to an adjacent face pair. Preferably, the faces of a face pair are adjusted symmetrically relative to each other. The device is configured to do this. The positioning of at least one face of the face pairs relative to the longitudinal axis is adjustable. The positioning preferably includes the inclination of the relevant face relative to the longitudinal axis and/or the spacing relative to the longitudinal axis. In other words, the positioning of at least one face of the face pairs is adjustable relative to the other face of the face pair. The positioning then preferably includes the inclination of the relevant face relative to the other face of the face pair and/or the spacing from the other face of the face pair (for instance, with respect to the face center of the respective face).

The inlet is preferably provided as an inlet face and the outlet is provided as an outlet face. The inlet and outlet are open faces, through which melt can be introduced without impediment. The outlet face is greater than the inlet face and can particularly be adjusted (by adjusting the adjustable faces or faces). The inlet face is provided to be connected to one end of an extruder, in particular to a discharge die of an extruder. Additional processing apparatuses which are configured to process, that is to say, form and/or cut the foam member, can adjoin the outlet. At the outlet, the spacing between two opposing faces (in particular lateral faces) is preferably greater than at the inlet and may be, for example, at least 150%, 180%, 220% or 250% of the spacing at the inlet. This may apply only to one orientation, for instance, a horizontal spacing, while in a vertical orientation (that is to say, an orientation perpendicular thereto) the spacing between opposite faces at the inlet may correspond to a gap of only a few millimeters (or from 0.5 to 2 mm) and at the outlet is one or more centimeters (for example, at least 10 mm, at least 20 mm or at least 50 mm). The dimensions are intended to be adapted to different applications which may provide for substantially different dimensioning. The cross sectional surface-area which is defined by the faces, that is to say, the cross-section of the foaming space, increases from the inlet. In particular, the cross sectional surface-area of the channel which is defined by the faces is preferably a multiple of the cross sectional surface-area of the die. The maximum cross sectional surface-area defined, for example, by a group of face pairs which is provided at the inlet or a cross sectional surface-area defined by the faces which are located nearest the outlet, can be at least twice, four times or ten times the cross sectional surface-area of the die or the inlet. The maximum cross sectional surface-area defined by the faces which are located nearest the outlet can be at least four times, ten times or twenty times the cross sectional surface-area of the die or the inlet. The pressure in the melt is thereby substantially lower at these faces than at the inlet or at the die, whereby the faces can be adjusted more precisely and with less stress.

In particular, the longitudinal axis can lead through the center of the face of the inlet, that is to say, the inlet face, and in particular also lead through the center of the outlet face. Other reference points of the inlet and outlet are also possible in order to define the path of the longitudinal axis. Fixing elements can also be provided in order to connect the foam forming device to an extruder at the inlet of the foam forming device.

The inlet may have a rigid input. The inlet may be formed by a hollow member, for example, in the form of a (short) pipe (preferably, constructed in an internally rectangular or polygonal manner, in particular in the cross sectional shape of the face pairs which adjoin the input). The inlet comprises walls which extend completely circumferentially. The walls are preferably rigid. The input can further have the mentioned fixing elements or portions thereof in order to allow fixing to an upstream extruder. The cross section of the input preferably corresponds to the cross section of the face pairs at the location at which the face pairs adjoin the input. The cross section of the input is preferably constant along the longitudinal extent (that is to say, along the longitudinal axis) of the input, but may also expand in the direction toward the face pairs, that is to say, from the inlet in the direction of the outlet. The spacing of the faces of the face pairs can also expand in this direction. The input can be formed by a hollow member with the same cross sectional shape as the cross section of the face pairs at the location at which face pairs abut the input. The cross section of the input is preferably quadrangular, but may particularly also be in the form of a trapezium, parallelogram or rectangle. In particular, the input is constructed with a cross section which is rectangular, wherein the height of the side walls corresponds to a fraction of the horizontal walls. The fraction is, for example, no more than 30%, 10%, 5% or 3%. Foam webs with the desired width and thickness can thereby be produced. This can also apply to one or more groups of face pairs, the circumference of which is configured geometrically in this manner; the shape of the cross section of the face pairs (in particular of the face pairs which adjoin the input) can correspond to the cross sectional shape of the input or the mentioned walls.

As mentioned, the foam forming device has a large number of face pairs. Each face pair has two opposite faces. The faces are preferably planar, but with bent faces also being considered. The faces of the face pairs can be bent in a direction which leads away from the longitudinal axis.

With respect to a central plane which extends through the centers of the inlet and outlet and which is particularly orientated vertically, the faces of each face pair are arranged symmetrically relative to each other. With respect to the longitudinal axis of the foam forming device, the faces of each face pair are arranged at the same height as the longitudinal axis (of the foam forming device). For each face pair, it is the case that the faces of the face pair are of identical size. The face pairs or the faces thereof are suitable for guiding the melt. The faces of the face pairs are made from a solid material. The faces of the face pairs are formed, for example, from a rigid, planar member. The faces of the face pairs are formed by surfaces of sheet pieces or plastics plates. The inner side of the face pairs may be provided with an anti-adhesion coating. The faces of one, all or a sub-group of the face pairs are parallel with each other. However, a face pair, the faces of which are inclined relative to each other, may be provided. Thus, a rectangle or parallelogram can be formed circumferentially by two face pairs if the first face pair and second face pair each have two mutually parallel faces, or a trapezium if the faces of the first face pair are mutually parallel and the faces of the second face pair are inclined relative to each other. However, more complex cross sectional shapes in the form of polygons with more than four sides can also be formed and/or cross sectional shapes with non-linear lines, for example, in face pairs with bent faces.

The face pairs or the faces thereof physically delimit a foaming space, in particular at least partially in a circumferential direction with respect to the longitudinal axis. The foaming space is further delimited by the inlet and the outlet, wherein they are open faces through which the melt or a foam member can be introduced. The delimitation by the inlet and the outlet are notional delimitations for defining the foaming space and not physical delimitations, as exist as a result of the face pairs. The open faces are suitable for guiding the foaming melt laterally (as a partially circumferential or completely circumferential wall) in order thus to define the cross section of a foam member. The face pairs and the faces thereof or the members which form the face pairs are consequently retained from the exterior in order to place a counter-pressure counter to the pressure of the foaming melt and thus to define the form of the foam member. Since at least one face of the face pairs or all the faces of a small number or all of the face pairs are adjustable, the foaming process can thereby be guided, in particular for homogenized foaming (that is to say, foaming which is identical as far as possible in different radial directions from the longitudinal axis).

In one example, the foam forming device comprises a first and a second face pair. Each face pair has two opposite faces. The faces of the different face pairs alternate circumferentially. The faces are planar and form a rectangle. The first and second face pair form a first group which follows the inlet. There are preferably additional groups of first and second face pairs which are constructed identically, but have a different inclination and/or a different spacing between the faces. The additional groups are arranged in rows beside each other in the direction of the longitudinal axis; the groups are consequently arranged in rows beside each other from the inlet to the outlet (perpendicularly to the circumferential direction).

A gap can be left between two groups in the direction of the outlet, for instance, in order to arrange a surface processing apparatus at that location. A group may have faces which leave a gap circumferentially in order to provide a surface processing apparatus at this gap. This group is preferably followed by at least one group without any gap, that is to say, with completely circumferential faces. Furthermore, an opening may be provided in a face (or in the faces of a face pair). This opening may be provided as a slot, circular hole, elongate hole or the like. Preferably, the main extent direction of the opening extends in an elongate opening along the width of the face (that is to say, transversely relative to the direction which is directed from the inlet to the outlet). A surface processing apparatus can be provided at the opening. This surface processing apparatus may, for instance, be a laminating station which is particularly configured to apply a plastics material, for instance, a plastics web, in particular made of non-foamed plastics material. The same plastics material, from which the foam web is also made, can be used for laminating by means of the laminating station. Such a laminating station can be configured to heat the plastics web so that at the opening a heated plastics material is applied to the not yet cooled foam member, that is to say, warm foam member (that is to say, the foam web resulting from the melt). The apparatus described here can also include the surface processing apparatus. There may further be provided as a surface processing apparatus a dyeing or printing apparatus which acts in the mentioned gap on the foam member or the foamed melt. The gap or the opening is preferably provided at locations where the foam member as a result of its temperature can still be plastically deformed, that is to say, at a height at which the foam member (in particular at the surface) is not yet completely solidified.

In general, a plurality of face pairs of the large number of face pairs are arranged beside each other in rows in a direction from the inlet to the outlet. The faces or face pairs which are arranged beside each other in rows along the same circumference or at the same height of the longitudinal axis belong to the same group. There may be a plurality of groups, that is to say, several rings which are arranged one behind the other, which are formed by the faces or face pairs. It is thereby possible to form an adjustable foaming space which increases from the inlet to the outlet, preferably in a vertical direction and in a width direction. As a result of the adjustability of the faces, the foaming space can also be adjusted to current process parameters, such as desired width or thickness of the foam, viscosity, conveying rate, vapor pressure of the propellant and the like, in particular in order to allow a uniform foaming (small foaming density, uniform cell form and/or size). A property of the foam forming device is therefore that the foaming space is adjustable (in terms of its extent) or the delimitation thereof is adjustable.

One aspect of the foam forming device is that face pairs (which are arranged circumferentially beside each other in rows) are provided, in particular at least the first and second face pair which delimit the foaming space substantially completely circumferentially. To this end, juxtaposed faces (or faces which are one behind the other) of the face pairs can abut each other directly or can preferably overlap at an edge. This particularly relates to face pairs which are arranged at the same height relative to the longitudinal axis. These are face pairs of the same group. A plurality of groups each having a plurality of face pairs can be provided and are arranged in rows beside each other along the longitudinal axis. Face pairs of mutually following groups can also abut each other or overlap at an edge. The face pairs can form a substantially continuous envelope (in the longitudinal axis direction) for the foaming space, particularly if a plurality of groups are arranged in rows beside each other. The substantially continuous envelope can reach from the inlet to the outlet.

Instead of a direct juxtaposition of adjacent faces (adjacent or with overlapping edge), a juxtaposition of the faces with gaps can also be considered. This allows a simplified adjustment of the faces. The gaps are preferably provided by gaps between adjacent faces which are no wider than 10 mm or 5 mm or preferably no wider than 2 mm or 1 mm. In special cases, the maximum width of the gaps can be 15 mm, 20 mm or 30 mm or 50 mm or 100 mm depending on the thickness of the foaming. Preferably, the gap is so narrow that, during foaming, no foam passes through the gap. Since this is highly dependent on the foaming material, the propellant and the process parameters, therefore, not only the mentioned maximum gap dimensions are conceivable. With a gap, the faces also form a complete delimitation for the foam if no foam passes through the gaps. The juxtaposition of adjacent faces or face pairs, as mentioned here, with a gap can relate to a circumferential juxtaposition, a juxtaposition in one direction from the inlet to the outlet or both.

Preferably, the face pairs have a cross section which is arranged in accordance with a quadrangle. The four sides of the quadrangle are formed by two face pairs, in particular by the two times two faces thereof. In this instance, the two face pairs are the first and second face pair. These face pairs are provided at the same height with respect to the longitudinal axis. The face pairs, in particular the first face pair and the second face pair, together circumferentially delimit the foaming space. The face pairs can, in the form of a quadrangle, form a quadrangle which has two mutually parallel sides, the sides of which can be divided into two pairs of mutually parallel sides or the sides of which are arranged perpendicularly to each other. The first face pairs can consequently, for example, be perpendicular to the second face pairs. Alternatively, the first face pairs can be located transversely (and not perpendicularly) to the second face pairs. The two face pairs can thus form a trapezium, a parallelogram or a rectangle (circumferentially or with respect to the cross section). For example, in order to produce or form foam webs, there are embodiments in which the face pairs form a rectangle in cross section. The lateral face pair, for instance, the first face pair, may have a height which corresponds only to a fraction of the length of the horizontal faces (that is to say, of the horizontally extending face pair). The fraction is, for example, no more than 30%, 10%, 5% or 3%, whereby a planar web for a number of applications can be produced. The faces of the first face pair can be described as the left face and right face, wherein this relates to the cross section. The faces of the second face pair can be described as the upper face and lower face, wherein this also relates to the cross section. The faces of the face pairs can be arranged symmetrically relative to each other, wherein preferably one or preferably two planes of symmetry, through which the longitudinal axis preferably extends, exist. In principle, a plurality of groups, which are arranged in rows beside each other along the longitudinal axis, each having two such face pairs can be provided. A plurality of face pairs of the large number of face pairs can be arranged in rows beside each other in a direction from the inlet to the outlet. In this instance, face pairs which are arranged in rows beside each other in a direction from the inlet to the outlet belong to different groups. In particular, a plurality of groups can be arranged in rows beside each other in a direction leading from the inlet to the outlet. Consequently, the groups are arranged in rows beside each other in a conveying direction and particularly along the longitudinal axis. Each group preferably has a plurality of face pairs which are arranged in rows beside each other circumferentially and preferably form a circumferential line (that is to say, a ring) which is substantially enclosed. The faces of the face pairs which are arranged beside each other in rows in the direction from the inlet to the outlet are preferably arranged in rows beside each other in a substantially gap-free or partially overlapping manner. The faces or face pairs which are arranged in rows beside each other together form a continuous inner face of the apparatus for guiding the foam.

Furthermore, in addition to the first face pair, there may be an additional face pair which adjoins the first face pair (or partially overlaps therewith) and which has the same orientation as the first face pair. Two opposite sides of the cross section are thereby formed by a plurality of face pairs. Alternatively, or additionally, in addition to the second face pair, there may be an additional face pair which adjoins the second face pair (or partially overlaps therewith) and which has the same orientation as the second face pair. Two (additional) opposite sides of the cross section can also thereby be formed by a plurality of face pairs. According to a comparable definition, the faces of one, several or all of the face pairs are cut into pieces and are formed as a juxtaposition of individual (physically independent) face pieces (plates or sheet pieces). Faces or plates with the same orientation are preferably arranged in a partially overlapping manner, but can also be arranged with gaps relative to each other, in particular with a gap as set out herein with reference to different groups or face pairs (which are arranged transversely to each other).

Another aspect is that the spacing between opposite faces of a sub-group or all of the face pairs increases in the direction toward the outlet of the foam forming device. This increase can be linear toward the outlet of the foam forming device, that is to say, have a constant rate of increase. Preferably, however, the percentage or absolute rate of increase at the inlet toward the outlet is greater than toward the outlet. One embodiment makes provision for the spacing in the first 10%, 20% or 30% between opposite faces or the cross sectional surface-area to increase to at least 40%, 60% or 90% of the spacing existing at the outlet or the cross sectional surface-area existing at the outlet. This takes into account the foaming tendency existing at the inlet or the propellant pressure which is greater than at the outlet. The cross sectional surface-area is in this case the cross sectional surface-area of the channel which is surrounded by the face pairs.

Additional embodiments make provision for the position of the adjustable faces relative to the longitudinal axis and/or a pressure which is applied by the adjustable faces in the direction of the foaming space to be adjustable. In this instance, particularly the bearing of the faces and face pairs is constructed accordingly, wherein the bearing can particularly be resilient or can be constructed with adjustable resilience. The adjustable bearing can relate to all the faces or face pairs, some of them or only one face or one face pair. The foam channel can thereby be adjustably narrowed (or expanded again). The bearing can be adjusted differently to different (length) portions. Alternatively, the faces or face pairs may not be supported resiliently, but instead rigidly. In this case, the actuators mentioned here can be used or screws/screw threads (with associated nuts) by means of which the bearing of the faces or face pairs is provided.

The apparatus may have actuators which support the adjustable face pairs. The actuators are configured to adjust the inclination and/or the position of the adjustable face pairs. The actuators may be part of the bearing or provide it. The bearing or the actuators can be adjusted by means of a signal (pressure signal, electrical signal, pneumatic or hydraulic adjustment). The actuators are configured to be adjusted during operation (and not or not only during maintenance).

The actuators support the face pairs preferably resiliently with respect to a counter-bearing, but may also not be supported resiliently. The actuators are preferably controlled resiliently, for example, by means of a resilient material, such as rubber, or are controlled in such a manner that a resilient behavior is produced.

The actuators may be pneumatic actuators, in particular bellows actuators. In this instance, there is a pneumatic access to each actuator so that, as a result of the internal pressure of the actuator, the position of the face which is fixed thereto and/or the resilience of the bearing which is provided by the actuator can be adjusted. Furthermore, the actuators may be hydraulic actuators, wherein in this instance a corresponding adjustability of pressure and/or position also results from the adjustable internal pressure. Furthermore, the actuators may be electromechanical actuators, for instance, in the form of a linear motor, a lifting magnet, electrical actuating drive or the like. Furthermore, there may be provided hybrid actuators which combine a plurality of these adjustment mechanisms, for example, an electrical actuating drive (or other electromechanical actuator) combined with a resilient actuator unit. Furthermore, the connection between the actuator and the counter-bearing or between the actuator and face/face pair can be resilient or can have a resilient element (adjustable or non-adjustable). Furthermore, screws/screw threads which particularly make provision for a non-resilient bearing can be provided for adjustment.

The foam forming device may further have a (pneumatic, hydraulic, electrical, etc.) control unit which is connected to the actuators in terms of control. A plurality of mutually adjacent face pairs can be provided, wherein the control unit is configured to adjust them so as to be juxtaposed without any gaps. In particular, a plurality of face pairs of the large number of face pairs can be arranged in rows beside each other in a direction from the inlet to the outlet, wherein the control unit is configured to adjust faces of the face pairs so as to be juxtaposed without any gaps.

An aspect of the arrangement of the face pairs is that the first face pair can be located between the second face pairs. The first face pair is preferably arranged at an angle relative to the second face pair, for instance, substantially at right-angles. In this instance, the first face pair can form the longer edge in cross section while the second face pair can form the shorter edge, in particular with a quadrilateral or in particular rectangular cross section. The first face pair is preferably the one which determines the thickness of the foam web (as a result of the spacing of the associated faces); the second face pair may be the one which determines the width of the foam web (as a result of the spacing of the associated faces). The first face pair can extend in a horizontal direction and the second face pair can extend in a vertical direction. In other words, the wider face pair (that is to say, the first face pair) can be arranged between the face pair, which is narrower in comparison therewith (that is to say, the first face pair). The second face pair which is narrower in comparison with the first face pair constitutes a lateral delimitation (in a second direction) for the first face pair or for the foaming space. The first face pair which is wider in comparison with the second face pair delimits the foaming space (in a second direction), but not the first face pair. The first direction may be the horizontal direction, the second direction may be the vertical direction. The cross section of the foaming space is preferably wider in a horizontal direction than in a vertical direction, whereby a lying foam web is produced, that is, a foam web which extends in a horizontal direction. This can relate only to a first portion (when viewed from the inlet to the outlet), wherein there may be a second portion, which particularly follows it in the direction toward the outlet and in which the first (transversely extending) face pair is not arranged between the second (lateral) face pair, but instead in a transposed manner the second (lateral) face pair is arranged between the first (transversely extending) face pair.

Another aspect is the use of a plurality of face pairs which are arranged in rows beside each other from the inlet toward the outlet (“conveying direction”), in particular in abutment against each other, without gaps (that is to say, with a gap of less than 10 mm, 5 mm, 2 mm or 1 mm) or partially overlapping. Consequently, faces of the face pairs are arranged in rows beside each other in a conveying direction of the web, whereby the foaming in the conveying direction can be influenced individually at several locations (in the conveying direction). When viewed from above, a row of face pairs is produced; the face pairs which follow each other from the inlet to the outlet can be described as successive groups of face pairs. Consequently, there may be a plurality of first and a plurality of second face pairs which are arranged in several groups in rows beside each other in the direction from the inlet to the outlet. The first face pairs are preferably offset relative to each other along the circumference of the foaming space with respect to the second face pairs. One example would be first face pairs which, with respect to the circumference, are perpendicular to the second face pairs, wherein the first face pairs with respect to the cross section extend longitudinally while the second face pairs extend laterally.

Another aspect is that there is provided in a first portion from the inlet at least a first group in which the first face pair is located between the second face pair, wherein furthermore at least one second group in which the second face pair is located between the first face pair is provided. Preferably, the second group follows the first group in the direction toward the outlet. Directly after the inlet, the foaming can thereby be controlled in terms of height by the (at least one) face pair of the first group independently of the (at least one) second face pair (because it is not located between the first face pair at that location). In order subsequently to form the lateral edges of the foam web, in the second group the (at least one) second face pair is between the (at least one) first face pair, that is to say, no first face pair is located between the second face pair so that the second face pair can be freely controlled. In the first group, the at least one second face pair does not impede the spacing adjustment of the first face pair and in the second group the spacing adjustment of the second face pair is not impeded by the first face pair. Which face pair is located between which consequently alternates in a direction from the inlet to the outlet.

The inlet preferably has a die. The face pairs preferably adjoin this die in a substantially gap-free manner (in particular with a maximum spacing of less than 2 mm or 1 mm). Furthermore, the die can be arranged between the face pairs (which come first, when viewed from the inlet). The guiding of the foam web thereby begins by means of the face pairs directly at the inlet and in particular directly at the die. The die can be a wide-slot die. The die may have a slot in the form of a rectangle with a side ratio (width to height) of more than 50, 100 or 300. The width inside the die may further be adjustable. The width of the die opening is measured in the circumferential extent direction of the first face pair. The height of the die opening is measured along the circumferential extent direction of the second face pair, particularly if the foaming space has a quadrilateral or in particular rectangular cross section. The die can be a temperature-controllable die, for instance, a cooled die, for instance, a cooled wide-slot die.

There may further be provision for at least a portion of the face pairs to be configured in a temperature-controllable manner, for instance, for cooling or heating. The face pairs are particularly formed by two opposite guide faces or plates. The guide faces or plates of all or some of the face pairs can be configured in a temperature-controllable manner.

A foam extrusion apparatus is further described. It has a foam forming device, as set out herein. The foam extrusion apparatus further has an extruder which is connected upstream of the foam forming device. In particular, the extruder has an outlet, which the inlet of the foam forming device adjoins (in particular in a substantially gap-free manner). Preferably, the die of the foam forming device is directly connected to the extruder. Additional embodiments of the foam extrusion apparatus provide for the extruder to have an extrusion die which is particularly constructed similarly to the die, which is described here, of the foam forming device. The foam forming device is connected to the extruder and the extrusion die thereof in such a manner that the face pairs (at least the face pairs at the inlet of the foam forming device) or at least a first face pair adjoin(s) directly (without gaps) against the extrusion die. There is particularly no substantial spacing (>1 mm, 5 mm or 10 mm) or no intermediate space between the die or extrusion die, on the one hand, and the guide plates of the face pairs, on the other hand.

The foam extrusion apparatus may be in the form of an installation for producing foam and subsequently processing foam members. This installation or foam extrusion apparatus can further have a cutting apparatus. This cutting apparatus is arranged downstream of the foam forming device, that is to say, provided downstream of the cutting apparatus in the conveying direction. The cutting apparatus is configured to cut individual foam members from a continuous foam web. Furthermore, the foam extrusion apparatus can further have a packaging apparatus. The processing line of the installation which extends from the cutting apparatus as far as the packaging apparatus is preferably constructed so as to be free from surface-abrading devices. Since, as mentioned in the introduction, the adjustment of the faces allows very precise control of the thickness and form of the foam web or foam members, an aspect of the invention produces foam members which do not necessarily have to be processed by means of surface abrasion. The processing line between the cutting apparatus and packaging apparatus consequently preferably does not have any planing device (or no planer/grinder unit). Work can thereby be carried out with less waste and in particular with a non-opened surface. Dispensing with a surface abrasion at the upper/non-opened side of the foam members (regardless of the cutting of edges or introduction of grooves or profiling) leads in the foam member to substantially less diffusion activity which would be disadvantageous for the thermal insulation properties since the surface is not opened after the foaming at least to an extremely great extent. A substantially better constancy of the insulation action is produced.

The processing line may have a cooling device and/or an embossing roller. Processing lines which have an edge processing device, profiling device and/or phase cutting device are also described as a processing line which is free from surface-abrading devices. Since they act only on a small portion of the surface, the effects thereof on the total surface are negligible. Embossing (where applicable also profiling and edge-cutting) is/are not intended to be understood in this instance to be surface-abrading steps because they act only on a small width of the foam member (less than 25%, less than 10% or less than 5%).

The foam extrusion apparatus can further have a plasma processing device (or corona processing apparatus). It can be arranged downstream of the cutting device or a side cutting device of the foam extrusion apparatus. As a result, the (slight) openings of the surface can be closed again. In a closed surface, fewer diffusion effects which can result, for example, in the air components being introduced into the cells, result in a closed surface, wherein this would result in poorer thermal insulation properties.

There may also be provided a surface processing apparatus in the form of a laminating apparatus or a corona processing apparatus which is configured to apply a non-foamed plastics layer (preferably made from the same plastics material as the foam web). The surface can also be sealed thereby. The laminating apparatus (also referred to as a laminating station) can be arranged downstream of the foam foaming device, but is preferably arranged at a gap of the laminating station or at an opening of a face thereof in order to process the still plastically deformable surface of the foam member or the foamed melt, that is to say, in order to apply a layer of non-foamed plastics material at that location.

A (an additional) foam forming device can follow the plasma processing device and/or laminating apparatus, as described here. This allows processing of the foam member or the foam web after the plasma processing or after the lamination in order thus to configure the form of the foam member precisely according to specifications.

The foam forming device can as mentioned be provided with a laminating apparatus (where applicable, alternatively in conjunction therewith with plasma processing device). The foam forming device can be provided with a plurality of groups which are arranged in rows beside each other from the inlet to the outlet, but with one of the groups being able to be omitted or faces of a group being able to be omitted in order thus to form a gap. A surface processing apparatus can be provided at this gap or at an opening in a face of the foam forming device in order to process the surface of the foam web at this gap or opening. Faces or face portions which are provided (in the direction of the outlet) downstream of the gap (by omitting a face or through an opening in the face) then act substantially only on the laminated (or generally processed) layer so that surface properties (in particular of the laminated-on layer, for example, the thickness thereof) can thereby be precisely adjusted. Generally, for example, a laminating apparatus or dyeing apparatus (or a plasma processing device) can be provided as a surface processing apparatus. The group which is omitted in order to form the gap is preferably followed (toward the outlet) by at least one additional group which is particularly complete in order thus to bring the surface-processed foam web with the described faces or face pairs into form again. The opening in the face is further followed by at least one portion of the remaining closed face, wherein at least one additional face can also follow.

The faces or guide plates of the face pairs may be integral or in several pieces. In the last case mentioned, there are a plurality of face elements which preferably overlap each other. The plurality of face elements are arranged in rows beside each other in a direction perpendicular to the conveying direction. The plurality of face elements are arranged in rows beside each other in a direction which leads from a face of the adjacent face pair to the opposite face of the adjacent face pair (in accordance with an overlap direction). In this case, faces of first face pairs have a plurality of face elements which overlap each other in the direction toward the faces of the second face pairs (overlap direction, that is to say, perpendicular to the conveying direction). Faces of second face pairs have in this case a plurality of face elements which overlap each other in the direction toward the faces of the first face pairs. There may be provided one or more groups which have (in particular second) face pairs, the faces of which are constructed in several pieces by face elements. Instead of an overlap of the face elements of the same face, an abutting arrangement of the face elements can also be provided, in particular without gaps.

### BRIEF DESCRIPTION OF THE DRAWINGS

FIGS. 1 to 4 serve to explain in greater detail the foam forming device which is described herein.

### DETAILED DESCRIPTION OF THE INVENTION

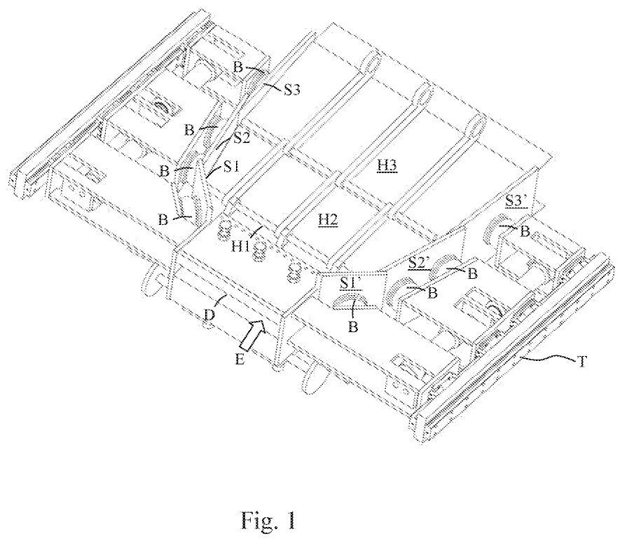

FIG. 1 shows a perspective view of an apparatus with an inlet E which follows a die D. The die D is a wide-slot die.

In order to form the foam which is discharged from the die D, first laterally arranged face pairs are used. The (first) face pair S1, S1′ directly adjoins the die, wherein the edge, which faces the die D, of this face pair is part of the inlet. The additional first face pairs S2, S2′ and S3, S3′ adjoin this first face pair S1, S1′ in this sequence. It can be seen that the faces of these face pairs overlap each other. At a transition of a first face pair to the next first face pair (in a direction which is directed away from the inlet E), the edge of the face pair above the next face pair which is located nearer the inlet E is located. When viewed from the surrounded foaming space, the first face pairs merge into each other and form a (virtually) continuous inner face. The faces, which are designated S . . . , of the face pairs are laterally arranged and delimit the foaming space laterally. The relevant face pairs extend laterally (and substantially in the conveying direction) and have faces which are spaced apart transversely relative to the conveying direction and between which the foaming space R is located.

Furthermore, there are second face pairs H1-H3 which extend substantially in the conveying direction and transversely relative to the first face pairs. In cross section, faces of the first face pairs and faces of the second face pairs alternate with each other in a circumferential direction. The upper faces of the second face pairs can be seen. The second face pair H1 directly adjoins the die D (or forms a portion of the inlet E), with the additional second face pairs H2, H3 adjoining in this sequence. The second face pairs also form a continuous inner face (when viewed from the foaming space).

The face pairs H1 and S1, S1′ form a first group and surround the foaming space. This also applies to the face pairs H2 and S2, S2′ which form a second group and to the face pairs H3 and S3, S3′ which form a third group. Each group completely surrounds the foaming space in a circumferential direction. The first group is located directly at the inlet, wherein the second and third groups adjoin it in this sequence (in an overlapping manner). A circumferential inner face which is continuous in the conveying direction (a direction directed away from the inlet) and which is formed by the face pairs is produced.

It can be seen that, for the face pairs which are illustrated in FIG. 1, the transversely extending (horizontal) face pairs H1-H3 are enclosed by the lateral face pairs S1, S1′-S3, S3′. Additional groups can follow, wherein this is transposed. The first and second face pairs of the same group are arranged at the same height in a direction directed away from the inlet E. In particular, the centers of the first and second face pairs of the same group can substantially be provided in the same cross sectional plane (that is to say, at the same distance from the inlet E). A transition between first successive face pairs is provided at the distance from the inlet at which the transition between second successive face pairs is also provided. The transitions between the successive groups are at the same location, that is to say, at the same spacing from the inlet, for the relevant first and second face pairs.

FIG. 1 illustrates that the lateral face pairs are provided in a frame T and are supported with respect to the frame T by bellows elements B. The bellows elements can be acted on with an adjustable internal pressure so that the position and/or the pressing pressure of the relevant face pairs can be adjusted with respect to the foam in the inner space. The foaming process can thereby be adjusted. The face pairs H1-H3 can also be adjusted in terms of their position.

The first face pairs S1, S1′-S3, S3′ initially extend, when viewed from the inlet E, at a greater angle apart from each other than in the subsequent extent in a direction directed away from the inlet E. While the faces of the face pair S3, S3′ (further away from the inlet E than S1, S1′) have only a comparatively small opening angle and are virtually parallel with each other, the faces of the fac pair S1, S1′ (at the inlet E) have a substantially greater opening angle in comparison with S3, S3′. With the distance from the inlet, the opening angle (which is open relative to the outlet) decreases between the faces of the face pairs.

FIG. 1 shows a foam forming device, in which the face H3/the face pairs S3, S3′ is/are followed by the outlet. However, one embodiment of the foam forming device provides for a first portion which is constructed similarly to the arrangement illustrated in FIG. 1 and which is followed by a second portion. This is explained in greater detail with reference to the additional Figures.

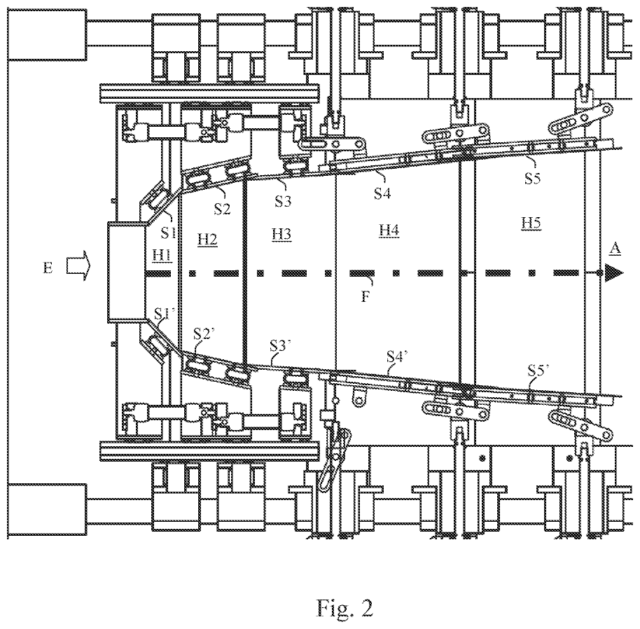

FIG. 2 shows a plan view of a foam forming device having first face pairs S1, S1′-S3, S3′ as illustrated in FIG. 1, and having additional successive first face pairs S4, S5. The second face pairs H1-H3 (that is to say, the three face pairs which are closest to the inlet E/the die) are laterally surrounded by the first face pairs S1, S1′-S3, S3′. This changes with the successive first and second face pairs H4, H4 and S4, S4′; S5, S5′ (in the direction away from the inlet), in which the first (lateral or vertically orientated) face pairs S4, S4′ and S5, S5′ are provided between the second face pairs H4, H5 (that is to say, the transversely extending or horizontally orientated face pairs). This allows without substantial unused structural space selective control of the foaming in the first region at the inlet A and in a subsequent second region at the outlet A. The dot-dash arrow F indicates the conveying direction which extends from the inlet and which leads in the direction of the outlet. The mentioned portions and groups are arranged in rows beside each other in this conveying direction; the successive groups have faces which overlap each other.

The first group is formed by the first face pair S1, S1′ and the second face pair H1. The second group is formed by the first face pair S2, S2′ and the second face pair H2. The third group is formed by the first face pair S3, S3′ and the second face pair H3. These groups are arranged in rows beside each other in the direction of the arrow F (conveying direction) and all have the property that the first face pairs H1-H3 are arranged between the second face pairs (S1, S1′ and S2, S2′ and S3, S3′). These three groups can be referred to as the first portion. It can be seen that the groups of the first portion can also be provided in numbers different from three, for instance in the form of only one group or two groups or more than three groups. This is dependent on the application, in particular the intended size of the foam product and the foaming behavior thereof.

There follows a second portion, in which the property which is mentioned in the preceding paragraph is transposed. The second portion has a fourth and a fifth group. The fourth group is formed by the first face pair S4, S4′ and the second face pair H4. The fifth group is formed by the first face pair S5, S5′ and the second face pair H5. These groups are arranged in rows beside each other in the direction of the arrow F (conveying direction) and follow the groups of the first portion. The fourth and fifth groups each have the property that the second face pairs (S4, S5′ and S2, S2′ and S3, S3′) are arranged between the first face pairs H4, H5. These two groups can be referred to as the second portion. It can be seen that the groups of the second portion can also be provided in numbers different from two, for instance, in the form of only one group or three or more than three groups. This is dependent on the application, particularly the intended size of the foam product and the foaming behavior thereof.

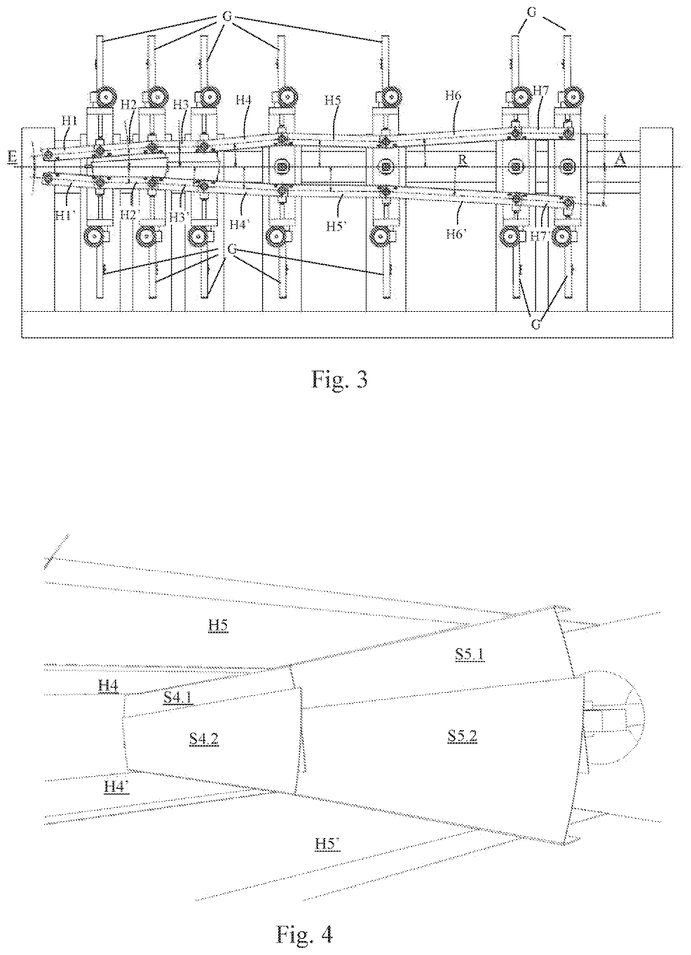

FIG. 3 shows the apparatus of FIG. 2 as a longitudinal section. The first face pairs H1, H1′/H2, H2′/H3, H3′/H4, H4′/H5, H57 H6, H6′ and H7, H7′ which are arranged in rows beside each other in the conveying direction can be seen. There are further shown actuators G, by means of which the position and/or the pressure which is applied by the face pairs can be adjusted in the direction of the foaming space R. The actuators G may be different from the bellows elements B which are used to adjust the second face pairs. In particular, the actuators G may be spindle drives.

The spacings of the first face pairs (that is to say, between the faces of the face pairs) of FIG. 3 increase from the inlet E in the direction A. This corresponds to the thickness increase of the foam member in the course of the foaming process. In at least one longitudinal portion of the illustrated apparatus, the first (horizontal) face pairs can be arranged between the second (lateral) face pairs. In at least one additional longitudinal portion of the illustrated apparatus, the second (lateral) face pairs can be arranged between the first (horizontal) face pairs.

FIG. 4 shows a detail of a foam forming device, as described herein, and corresponds to an inner view which can be seen from the foaming space toward the inner sides of the face pairs. It can be seen that the faces of the second face pairs (only one of the two lateral faces can be seen) are in two pieces (generally: several pieces) and have mutually displaceable and overlapping face elements S4.1, S4.2 and S5.1 and S5.2. Thus, a face of a second face pair is formed by the face elements S4.1 and S4.2 or by the vertical, overlapping juxtaposition thereof. The face, which follows it in the conveying direction, of an additional second face pair is formed by the face elements S5.1 and S5.2 or by the vertical, overlapping juxtaposition thereof. The juxtaposition of the face formed by the face elements S4.1 and S4.2 is located between the first face pair H4, H4′. They are part of the same group. The juxtaposition of the face formed by the face elements S5.1 and S5.2 is located between the second face pair H5, H5′. They are part of an additional group which follows (in the conveying direction). The face elements of the same face are preferably supported displaceably relative to each other, in particular in a direction perpendicular to the conveying direction, but preferably not displaceably in the conveying direction.

The first face pairs illustrated in the Figures extend horizontally and can also be described as horizontal face pairs or transversely extending face pairs. The second face pairs which are illustrated in the Figures extend vertically and can also be described as vertical face pairs or laterally extending face pairs. However, this depends on the orientation during the assembly and applications so that this description is preferably used only to explain the embodiments of the Figures.

1. A foam forming device having an inlet, an outlet and a longitudinal axis which leads from the inlet to the outlet, and having a large number of face pairs, wherein the face pairs each have two opposite faces and the faces at least partially delimit a foaming space, wherein the large number of face pairs have a first face pair and a second face pair, wherein at least one of the faces of the first face pair is an adjustable face, the positioning of which relative to the longitudinal axis is adjustable, and at least one of the faces of the second face pair is an adjustable face, the positioning of which relative to the longitudinal axis is adjustable, wherein the first face pair and the second face pair are offset relative to each other along the circumference of the foaming space.

2. The foam forming device as claimed in claim 1, wherein the face pairs delimit the foaming space substantially completely circumferentially.

3. The foam forming device as claimed in claim 1, wherein the first face pair and the second face pair together delimit the foaming space circumferentially and the face pairs form a quadrangle, a trapezium, a parallelogram or a rectangle.

4. The foam forming device as claimed in claim 1, wherein the position of the adjustable faces relative to the longitudinal axis and/or a pressure which is applied by the adjustable faces in the direction of the foaming space is adjustable.

5. The foam forming device as claimed in claim 1, wherein the faces of the face pairs are planar or are bent in a direction which leads away from the longitudinal axis.

6. The foam forming device as claimed in claim 1, wherein a plurality of face pairs of the large number of face pairs are arranged beside each other in rows in a direction from the inlet to the outlet.

7. The foam forming device as claimed in claim 6, wherein the faces of the face pairs which are arranged in rows beside each other in the direction from the inlet to the outlet are arranged beside each other in rows in a substantially gap-free or partially overlapping manner.

8. The foam forming device as claimed in claim 1, wherein the spacing between opposite faces of a sub-group or all of the face pairs increases in the direction toward the outlet of the foam forming device.

9. The foam forming device as claimed in claim 1, further comprising actuators which support the adjustable face pairs and which are configured to adjust the inclination and/or the position of the adjustable face pairs.

10. The foam forming device as claimed in claim 9, wherein the actuators support the face pairs resiliently with respect to a counter-bearing.

11. The foam forming device as claimed in claim 9, wherein the actuators are pneumatic actuators.

12. The foam forming device as claimed in claim 9, which further has a control unit which is connected to the actuators in terms of control, and furthermore a plurality of face pairs of the large number of face pairs are arranged in rows beside each other in a direction from the inlet to the outlet, wherein the control unit is configured to adjust faces of the face pairs in a state arranged in rows beside each other without any gaps.

13. The foam forming device as claimed in claim 1, wherein the first face pair is located between the second face pair and is arranged at an angle relative thereto.

14. The foam forming device as claimed in claim 1, wherein first and second face pairs are arranged in rows beside each other in a direction from the inlet to the outlet in several groups, and the first face pairs are offset relative to each other along the circumference of the foaming space with respect to the second face pairs and there is provided at least a first group in which the first face pair is located between the second face pair and there is provided at least one second group which follows the first group in the direction toward the outlet, and wherein the second face pair is located between the first face pair.

15. The foam forming device as claimed in claim 14, wherein there is provided between two successive groups a gap, at which a surface processing apparatus is arranged.

16. The foam forming device as claimed in claim 1, wherein an opening is provided in one of the faces, wherein at the opening a surface processing apparatus is arranged.

17. The foam forming device as claimed in claim 1, wherein the inlet has a die, which the face pairs abut in a substantially gap-free manner or the die is arranged between the face pairs.

18. The foam forming device as claimed in claim 1, wherein at least some of the face pairs are configured in a temperature-controllable manner.

19. A foam extrusion apparatus having a foam forming device as claimed in claim 1 and having an extruder which has an outlet, wherein the inlet of the foam forming device adjoins the outlet of the extruder in a substantially gap-free manner.

20. The foam forming device as claimed in claim 9, wherein the actuators are bellows actuators, electromechanical actuators, or hydraulic actuators.
